(19) United States
(12) Patent Application Publication
(10) Pub. No.: US 2019/0322128 A1
(43) Pub. Date: Oct. 24, 2019

(54) VEHICLE WHEEL ASSEMBLY INCLUDING A SELF-DEPLOYED WHEEL SHUTTER SYSTEM

(71) Applicant: GM Global Technology Operations LLC, Detroit, MI (US)

(72) Inventors: Chih-hung Yen, Bloomfield Hills, MI (US); Bahram Khalighi, Birmingham, MI (US); Taeyoung Han, Bloomfield Hills, MI (US); Jolene Xin Wei Ng, Ann Arbor, MI (US); Evan Lerner, Ann Arbor, MI (US); Muzhi Zhu, Ann Arbor, MI (US); Tung-Yi Chiu, Ann Arbor, MI (US); Devanshu Singla, Ann Arbor, MI (US); George Kitromelides, Ann Arbor, MI (US)

(73) Assignee: GM Global Technology Operations LLC, Detroit, MI (US)

(21) Appl. No.: 15/955,997

(22) Filed: Apr. 18, 2018

(51) Int. Cl. B60B 7/00; B60B 7/04

(52) U.S. Cl. CPC B60B 7/002; B60B 7/04; B60B 2900/1216; B60B 2900/513; B60B 7/0066

(57) ABSTRACT

A vehicle wheel assembly includes a vehicle wheel including a wheel body having a center. The vehicle wheel defines a plurality of openings arranged annularly around the center of the wheel body. The vehicle wheel assembly further includes a self-deployed wheel shutter system coupled to the vehicle wheel. The self-deployed wheel shutter system includes a hub plate, an annular rim disposed around the hub plate, and a plurality of shutter flaps. The shutter flaps are movable relative the vehicle wheel between an extended position and a retracted position. In the extended position, the shutter flaps cover the openings of the vehicle wheel to preclude air from flowing through the vehicle wheel. When the plurality of shutter flaps are in the retracted position, the openings are exposed, allowing the air to flow through the openings of the vehicle wheel.

### INTRODUCTION

The present application relates to a vehicle wheel assembly including a self-deployed wheel shutter system.

Vehicles, such as cars, include vehicle wheels that support the tires. The vehicle wheel has openings (e.g., thru-holes). Vehicles also include brake assemblies coupled to the vehicle wheels. The brake assembly can decelerate the vehicle and at least includes a brake rotor and a brake shoe movably coupled to the brake rotor. The openings extend completely through the wheel body to allow air to flow through the vehicle wheel and into the brake assembly to cool the brake assembly. It is desirable to cool the brake assembly to extend its useful life. For this reason, the openings are configured as thru-holes that extend completely through the wheel body to allow air to cool the brake assembly. However, the openings may increase aerodynamic drag while the vehicle is traveling at relatively high speeds (e.g., 55 mph), which may in turn adversely affect fuel economy. It is desirable to balance fuel economy (which may be affected by aerodynamic drag) and brake performance (which may be affected by brake cooling). To do so, the presently disclosed vehicle wheel assembly includes a self-deployed wheel shutter system coupled to the vehicle wheel for covering the openings at predetermined vehicle speeds in order to minimize the aerodynamic drag of the vehicle and thereby improve fuel economy in comparison with other vehicles.

### SUMMARY

In some embodiments, the vehicle wheel assembly includes a vehicle wheel including a wheel body having a center. The vehicle wheel defines a plurality of openings arranged annularly around the center of the wheel body. The vehicle wheel assembly further includes a self-deployed wheel shutter system coupled to the vehicle wheel. The self-deployed wheel shutter system includes a hub plate, an annular rim disposed around the hub plate, and a plurality of shutter flaps arranged annularly around the hub plate. Each of the plurality of shutter flaps is pivotally coupled to the hub plate such that a rotation of the hub plate in a first rotational direction causes each of the plurality of shutter flaps to move simultaneously toward the annular rim. Each of the plurality of shutter flaps is pivotally coupled to the hub plate such that a rotation of the hub plate in a second rotational direction causes each of the plurality of shutter flaps to move simultaneously toward the annular rim. The first rotational direction is opposite to the second rotational direction. The plurality of shutter flaps are movable relative to the vehicle wheel between an extended position and a retracted position. In the extended position, the plurality of shutter flaps cover the plurality of openings of the vehicle wheel to preclude air from flowing through the vehicle wheel. When the plurality of shutter flaps are in the retracted position, the openings are exposed, allowing the air to flow through the openings of the vehicle wheel.

The self-deployed wheel shutter system may further include a guide rail assembly. The guide rail assembly includes a support plate and a plurality of guide rails extending radially outward from the support plate. The annular rim completely surrounds the hub plate. Each of the plurality of guide rails is directly coupled to the annular rim. Each of the plurality of guide rails extends linearly from the support plate to the annular rim. Each of the plurality of shutter flaps is coupled to one of the plurality of guide rails to guide a movement of the plurality of shutter flaps. The support plate has an annular shape and defines a central plate hole. The self-deployed wheel shutter system further includes a torsion spring disposed in the central plate hole. The torsion spring is coupled to the hub plate to bias the hub plate to rotate toward the second rotational direction in order to simultaneously move the plurality of shutter flaps away from the hub plate. The annular rim is configured to be fixed to the vehicle wheel such that the annular rim remains stationary relative to the vehicle wheel. The annular rim defines a plurality of arch-shaped slots, and each of the plurality of arch-shaped slots is sized to partially receive one of the plurality of the shutter flaps. The hub plate includes an annular plate portion and a plurality of extensions protruding radially outward from the annular plate portion. The self-deployed wheel shutter system includes a plurality of pivot pins, each of the plurality of pivot pins pivotally couples one of the plurality of the shutter flaps to one of the plurality of extensions to allow each of the plurality of shutter flaps to pivot relative to the hub plate. Each of the plurality of guide rails defines a groove, and the groove has a linear shape. The self-deployed wheel shutter system further includes a plurality of sliding pins. Each of the plurality of sliding pins is coupled to one of the plurality of shutter flaps. Each of the plurality of sliding pins is configured to be slidably received by the groove to allow each of the plurality of shutter flaps to move simultaneously with respect to the annular rim. The vehicle wheel assembly further includes a base plate configured to be fixed to the vehicle wheel, wherein the hub plate is disposed between the base plate and the support plate. The present disclosure also includes a vehicle including a vehicle body and a vehicle wheel assembly as described above.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic perspective, fragmentary view of a vehicle, wherein the vehicle includes a self-deployed wheel shutter system.

FIG. 2 is a schematic perspective view of the self-deployed wheel shutter system of FIG. 1, depicting the shutter flaps of the self-deployed wheel shutter system in a retracted position.

FIG. 3 is a schematic perspective, exploded view of the self-deployed wheel shutter system of FIG. 2, depicting only one shutter flap.

FIG. 4 is a schematic perspective view of the self-deployed wheel shutter system of FIG. 2, depicting the shutter flaps of the self-deployed wheel shutter system in an extended position.

FIG. 5 is a schematic perspective view of the self-deployed wheel shutter system without a hub cap, depicting the shutter flaps in the extended position.

FIG. 6 is a schematic, cross-sectional view of the self-deployed wheel shutter system, taken along section line 6-6 of FIG. 2.

FIG. 7 is a schematic, top perspective, fragmentary view of the self-deployed wheel shutter system of FIG. 2, depicting one guide rail, a portion of the annular rim, and one shutter flap.

FIG. 8 is a schematic, bottom perspective, fragmentary view of the self-deployed wheel shutter system of FIG. 2, depicting one guide rail, a portion of the annular rim, and one shutter flap.

FIG. 9 is a schematic, perspective, fragmentary cross-sectional view of the self-deployed wheel shutter system of FIG. 2, depicting one guide rail, a portion of the annular rim, and one shutter flap, taken along section line 9-9 of FIG. 8.

FIG. 10 is a schematic front view of a vehicle wheel assembly including a self-deployed wheel shutter system in accordance with another embodiment of the present disclosure.

FIG. 11 is a schematic rear view of the vehicle wheel assembly including the self-deployed wheel shutter system shown in FIG. 10, depicting one of the shutter flaps in a retracted position.

FIG. 12 is a schematic rear view of the vehicle wheel assembly including the self-deployed wheel shutter system shown in FIG. 10, depicting one of the shutter flaps in an extended position.

FIG. 13 is a schematic front view of a vehicle wheel assembly including a self-deployed wheel shutter system in accordance with another embodiment of the present disclosure, depicting one of the shutter flaps in a retracted position.

FIG. 14 is a schematic front view of a vehicle wheel assembly including a self-deployed wheel shutter system in accordance with another embodiment of the present disclosure, depicting one of the shutter flaps in an extended position.

FIG. 15 is a schematic front view of a vehicle wheel assembly including a self-deployed wheel shutter system in accordance with another embodiment of the present disclosure.

FIG. 16 is a schematic perspective view of a wedge-shaped blade, a peg, and a bar of the self-deployed wheel shutter system shown in FIG. 15.

### DETAILED DESCRIPTION

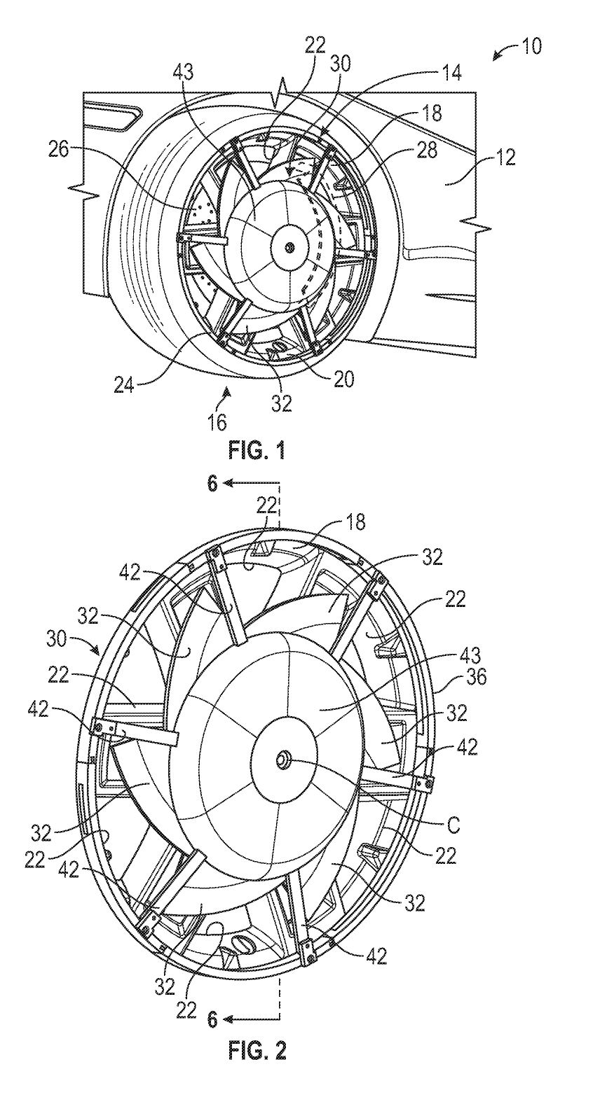

Referring to the drawings, wherein like reference numbers correspond to like or similar components throughout the several figures, and beginning with FIG. 1, a vehicle 10 (e.g., a car) includes a vehicle body 12, a vehicle wheel assembly 14 coupled to the vehicle body 12, and a tire 16 coupled to the vehicle wheel assembly 14. The vehicle wheel assembly 14 includes a vehicle wheel 18 coupled to the tire 16. Therefore, the vehicle wheel 18 supports the tire 16. The vehicle wheel 18 includes a wheel body 20 and has a plurality of openings 22 (e.g., thru-holes) extending completely through the wheel body 20. The vehicle 10 includes a brake assembly 24 coupled to the vehicle wheel 18. The brake assembly 24 is configured to decelerate the vehicle 10 and at least includes a brake rotor 26 and a brake shoe 28 movably coupled to the brake rotor 26. The openings 22 extend completely through the wheel body 20 to allow air to flow through the vehicle wheel 18 and into the brake assembly 24 to cool the brake assembly 24. It is desirable to cool the brake assembly 24 to extends its useful life. For this reason, the openings 22 are configured as thru-hole that extend completely through the wheel body 20 to allow air to cool the brake assembly 24. However, the openings 22 may increase aerodynamic drag while the vehicle 10 is traveling at relatively high speeds (e.g., 55 mph), which may in turn adversely affect fuel economy. It is desirable to balance fuel economy (which may be affected by aerodynamic drag) and brake performance (which may be affected by brake cooling). To do so, the presently disclosed vehicle wheel assembly 14 includes a self-deployed wheel shutter system 30 coupled to the vehicle wheel 18 for covering the openings 22 at predetermined vehicle speeds in order to minimize the aerodynamic drag of the vehicle 10 and thereby improve fuel economy in comparison with other vehicles.

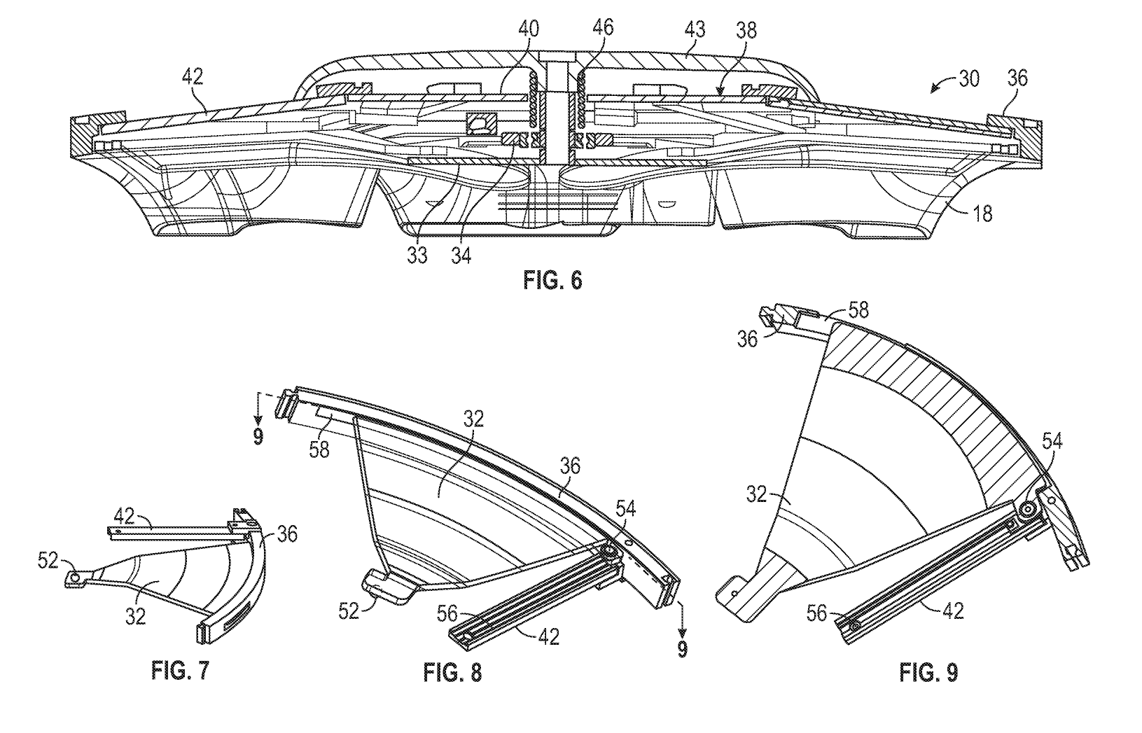

With reference to FIGS. 2-6, the self-deployed wheel shutter system 30 is coupled to the vehicle wheel 18 and can automatically deploy and retract shutter flaps 32 to cover and uncover the openings 22. The shutter flaps 32 are configured to be passively actuated (deploy or retract) at predetermined vehicle speeds (e.g., 45 miles per hour) to improve fuel economy while maintaining adequate cooling for the brake assembly 24. Specifically, the shutter flaps 32 are configured to move to (and remain in) the deployed (or extended) position solely when the vehicle 10 is traveling at speeds that are equal or greater than a predetermined vehicle speed (e.g., 45 miles per hour) in order to maximize fuel economy. Conversely, the shutter flaps 32 are configured to move to (and remain in) the retracted position solely when the vehicle 10 is traveling at speeds that are less than the predetermined vehicle speed (e.g., 45 miles per hour) in order to provide adequate brake cooling, thereby maximizing the life of the brake assembly 24. The self-deployed wheel shutter system 30 is passively actuated. In other words, the centripetal and spring force drive the shutter flaps 32 without the need of controllers or motors (which add mass and cost). The shutter flaps 32 define surfaces that are flushed with the vehicle wheel 18 to provide optimally minimized aerodynamic drag. The self-deployed wheel shutter system 30 may be a vehicle option for the vehicle wheel 18 or an after-market component that can be attached to the vehicle wheel 18.

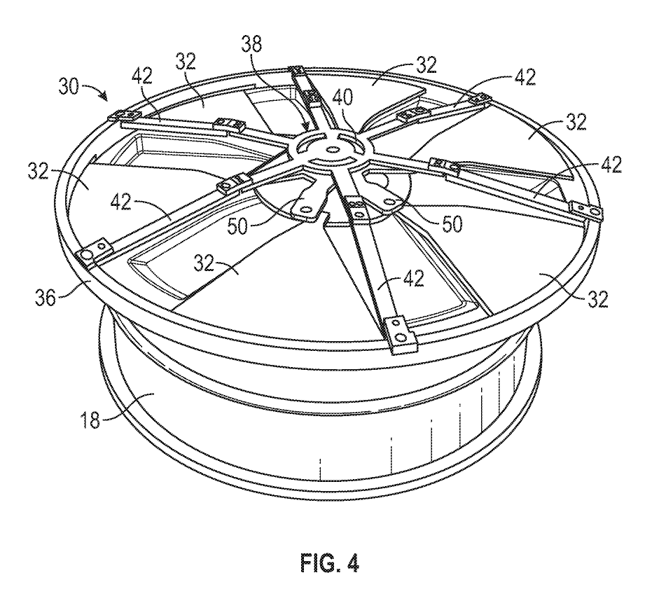

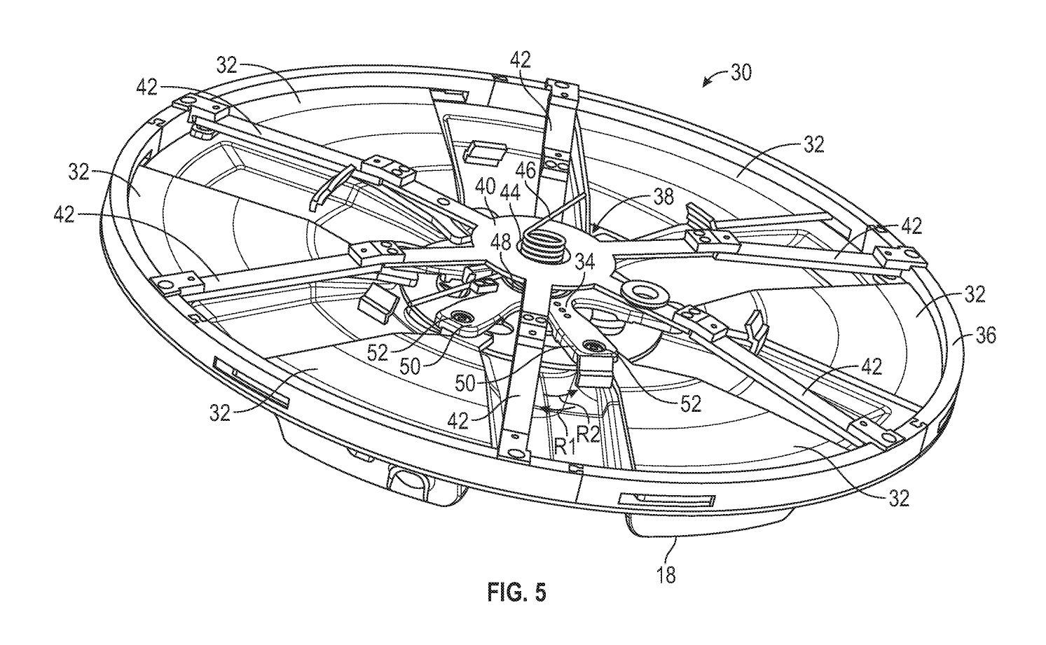

With reference to FIGS. 2-6, in addition to the shutter flaps 32, the self-deployed wheel shutter system 30 includes a hub plate 34 and an annular rim 36 disposed around the hub plate 34. The annular rim 36 completely surrounds the hub plate 34 to enhance the structural integrity of the self-deployed wheel shutter system 30. The self-deployed wheel shutter system 30 further includes the shutter flaps 32 (e.g., six shutter flaps 32) arranged annularly around the hub plate 34. The shutter flaps 32 may be disposed at different heights relative to each other to avoid interference when moving between the retracted position (FIG. 2) and the extended position (FIG. 4). Each shutter flap 32 is pivotally coupled to the hub plate 34. As such, rotating the hub plate 34 in a first rotational direction R1 causes each shutter flap 32 to move simultaneously toward the annular rim 36. Further, each of the shutter flaps 32 is pivotally coupled to the hub plate 34 such that rotating the hub plate 34 in a second rotational direction R2 causes each shutter flap 32 to move simultaneously toward the annular rim 36. The first rotational direction R1 is opposite to the second rotational direction R2. Due to the pivotal connection between the shutter flaps 32 and the hub plate 34, the shutter flaps 32 can move relative to the vehicle wheel 18 between the extended position (FIGS. 4 and 5) and the retracted position (FIG. 2). In the extended position (FIG. 4), the shutter flaps 32 completely cover the openings 22 of the vehicle wheel 18 to preclude air from flowing through the vehicle wheel 18, thereby reducing the aerodynamic drag of the vehicle 10 and maximizing fuel economy. When the shutter flaps 32 are in the retracted position (FIG. 2), the openings 22 are exposed, allowing the air to flow through the openings 22 of the vehicle wheel 18 to cool the brake assembly 24, thereby maximizing the useful life of the brake assembly 24.

The self-deployed wheel shutter system 30 further includes a guide rail assembly 38 for guiding the movement of the shutter flaps 32 relative to the annular rim 36. The guide rail assembly 38 includes a support plate 40 and a plurality of guide rails 42 extending radially outward from the support plate 40. In the depicted embodiment, the guide rail assembly 38 includes six guide rails 42. It is envisioned, however, that the guide rail assembly 38 may include more or fewer guide rails 42. Each guide rail 42 is directly coupled to the support plate 40. Each guide rail 42 is directly coupled to the annular rim 36 to enhance the structural integrity of the self-deployed wheel shutter system 30. The annular rim 36 of the self-deployed wheel shutter system 30 is directly coupled to a wheel body 20 of the vehicle wheel assembly 14 to enhance the structural integrity of the vehicle wheel assembly 14. The wheel body 20 is directly coupled to the vehicle wheel 18 to enhance the structural integrity of the vehicle wheel assembly 14. Each guide rail 42 extends linearly from the support plate 40 to the annular rim 36. Each shutter flap 32 is coupled to one of the plurality of guide rails 42 to guide the movement of the shutter flaps 32. The self-deployed wheel shutter system 30 further includes a hub cap 43 coupled to the guide rails 42 and partially covering all of the shutter flaps 32 for protection. In the depicted embodiment, the hub cap 43 is directly coupled to all of the guide rails 42 to enhance the structural integrity of the self-deployed wheel shutter system 30. A base plate 33 is fixed to the vehicle wheel 18, and the hub plate 34 is disposed between the base plate 33 and the support plate 40 to enhance the structural integrity of the self-deployed wheel shutter system 30. Accordingly, the base plate 33 remains stationary relative to the vehicle wheel 18.

As discussed above, the shutter flaps 32 can move relative to the vehicle wheel 18 between the extended position (FIG. 5) and the retracted position (FIG. 2). The shutter flaps 32 completely cover the openings 22 of the vehicle wheel 18 in the extended position (FIG. 5) to preclude air from flowing through the vehicle wheel 18, thereby minimizing the aerodynamic drag of the vehicle 10. The openings 22 are exposed when the plurality of shutter flaps 32 are in the retracted position (FIG. 2) to allow the air to flow through the openings 22 of the vehicle wheel 18 to cool the brake assembly 24. The support plate 40 has an annular shape to facilitate guiding all the shutter flaps 32 that are annularly arranged around the center C (FIG. 1) of the vehicle wheel 18. Further, the support plate 40 defines a central plate hole 44. The self-deployed wheel shutter system 30 further includes a torsion spring 46 disposed in the central plate hole 44. The torsion spring 46 is coupled to the hub plate 34 to bias the hub plate 34 to rotate toward the second rotational direction R2 in order to simultaneously move the shutter flaps 32 away from the hub plate 34. The annular rim 36 is fixed to the vehicle wheel 18. As such, the annular rim 36 remains stationary relative to the vehicle wheel 18.

With specific reference to FIG. 5, the hub plate 34 includes an annular plate portion 48 and a plurality of extensions 50 protruding radially outward from the annular plate portion 48. Each of the extensions 50 is directly coupled to the annular plate portion 48 to enhance the structural integrity of the hub plate 34. The self-deployed wheel shutter system 30 includes a plurality of pivot pins (see also FIGS. 7 and 8). Each of the pivot pins 52 pivotally (and directly) couples one of the plurality of shutter flaps 32 to one of the extensions to allow each of the plurality of shutter flaps to pivot relative to the hub plate 34 (FIG. 5). As such, rotating the hub plate 34 in the first rotational direction R1 causes each shutter flap 32 to move simultaneously (by pivoting about the respective pivot pin 52) toward the annular rim 36. Also, rotating the hub plate 34 in the second rotational direction R2 causes each shutter flap 32 to move simultaneously (by pivoting about the respective pivot pin 52) toward the annular rim 36. As mentioned above, the first rotational direction R1 is opposite to the second rotational direction R2. Alternatively, rotating the hub plate 34 in the first rotational direction R2 causes each shutter flap 32 to move simultaneously (by pivoting about the respective pivot pin 52) toward the annular rim 36. Also, rotating the hub plate 34 in the second rotational direction R1 causes each shutter flap 32 to move simultaneously (by pivoting about the respective pivot pin 52) toward the annular rim 36.

With reference to FIGS. 7-9, the self-deployed wheel shutter system 30 further includes a plurality of sliding pins 54. Each of the sliding pins 54 is directly coupled to one of the shutter flaps 32. Each of the guide rails 42 defines a groove 56 having a linear shape. Further, each of the sliding pins 54 is slidably received by the one of the grooves 56 defined by one of the guide rails 42, thereby allowing the shutter flaps 32 to move simultaneously with respect to the annular rim 36. In other words, the sliding engagement between the guide rails 42 and the shutter flaps 32 (via the sliding connection between the sliding pins 54 and the grooves 56) guides the movement of the shutter flaps 32 relative to the annular rim 36. The annular rim 36 defines a plurality of arch-shaped slots 58. Each of the arch-shaped slots 58 is configured, shaped, and sized to partially receive one of the shutter flaps 32 to help secure the shutter flaps 32 in the extended position (FIG. 5).

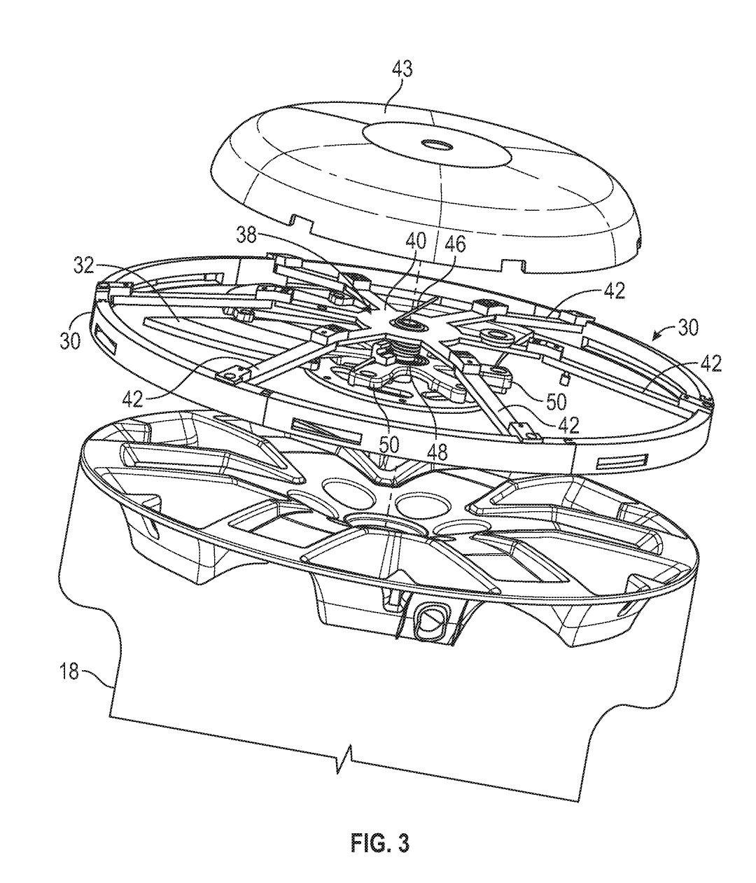

With reference again to FIGS. 2-6, during operation, due to the pivotal connection between the shutter flaps 32 and the hub plate 34 and the sliding connection between the shutter flaps 32 and the guide rails 42, the shutter flaps 32 can move relative to the vehicle wheel 18 between the extended position (FIGS. 4 and 5) and the retracted position (FIG. 2). The centripetal force (and optional spring force) drives the shutter flaps 32 toward the retracted position (FIG. 2) without the need of controllers or motors when the vehicle 10 is traveling at speeds lower than a predetermined threshold (e.g., 55 mph). Conversely, the centrifugal force drives the shutter flaps 32 toward the extended position (FIG. 3) when the vehicle 10 is traveling at or above the predetermined threshold (e.g., 55 mph). In the extended position (FIG. 4), the shutter flaps 32 completely cover the openings 22 of the vehicle wheel 18 to preclude air from flowing through the vehicle wheel 18, thereby reducing the aerodynamic drag of the vehicle 10 and maximizing fuel economy. When the shutter flaps 32 are in the retracted position (FIG. 2), the openings 22 are exposed, allowing the air to flow through the openings 22 of the vehicle wheel 18 to cool the brake assembly 24, thereby maximizing the useful life of the brake assembly 24.

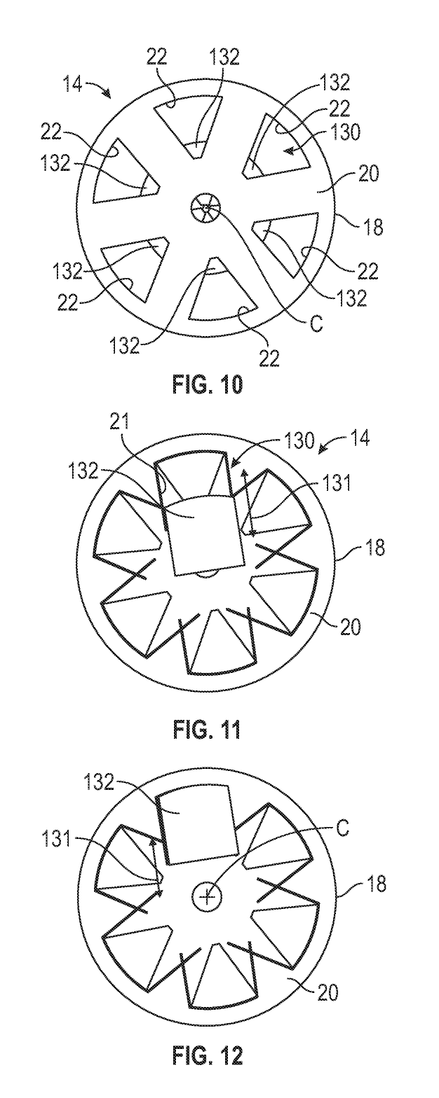

With reference to FIGS. 10-12, in another embodiment, the vehicle wheel assembly 14 includes another self-deployed wheel shutter system 130. In this embodiment, the vehicle wheel 18 also has the wheel body 20 and a plurality of openings 22 (e.g., thru-holes) extending completely through the wheel body 20. The openings 22 may have a substantially triangular shape. The self-deployed wheel shutter system 130 has shutter flaps 132 that glide along guideways 21 (FIG. 11) defined by the wheel body 20 along the direction indicated by double arrow 131 between the retracted position (FIG. 11) and the extended position (FIG. 12). Accordingly, each of the shutter flaps 132 is slidably coupled to the vehicle wheel 18. As such, each of the shutter flaps 132 is configured to slide linearly relative to the center C of the vehicle wheel 18. A spring may be connected to each shutter flap 132 to facilitate retraction. Although the drawings show one movable shutter flap 132, the number of shutter flaps 132 is equal to the number of openings 22.

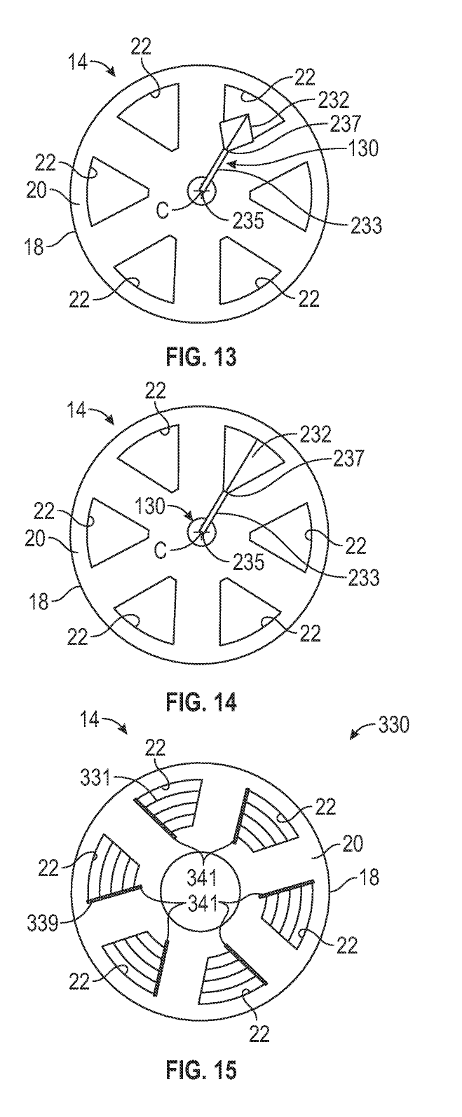

With reference to FIGS. 13 and 14, in another embodiment, the vehicle wheel assembly 14 includes another self-deployed wheel shutter system 130. In this embodiment, the vehicle wheel 18 also has the wheel body 20 and a plurality of openings 22 (e.g., thru-holes) extending completely through the wheel body 20. The openings 22 may have a substantially triangular shape. The self-deployed wheel shutter system 130 has shutter flaps 232 configured as a V-shaped foldable flap. In addition, the self-deployed wheel shutter system 130 includes a rod 233 pivotally coupled to the vehicle wheel 18 (near or at exactly at its center C) and the shutter flaps 232 (i.e., the V-shaped foldable flap). The rod 233 has a first rod end 235 and a second rod end 237 opposite the first rod end 235. The first rod end 235 is pivotally and directly coupled to the vehicle wheel 18, and the second rod end 237 is pivotally and directly coupled to the shutter flap 232. Consequently, the shutter flap 232 can unfold as it moves from the retracted position (FIG. 13) to the extended position (FIG. 14) in order to cover the opening 22. Also, the shutter flap 232 folds as it moves from the extended position (FIG. 14) to the retracted position (FIG. 13) to uncover the opening. The shutter flaps 232 and rod end 235 slides in the direction in or out of the paper to open or close the wheel vents (i.e., the openings 22). The vehicle wheel assembly 14 may also include six separate compression or tension springs for each shutter flaps 232 to work against centripedal force.

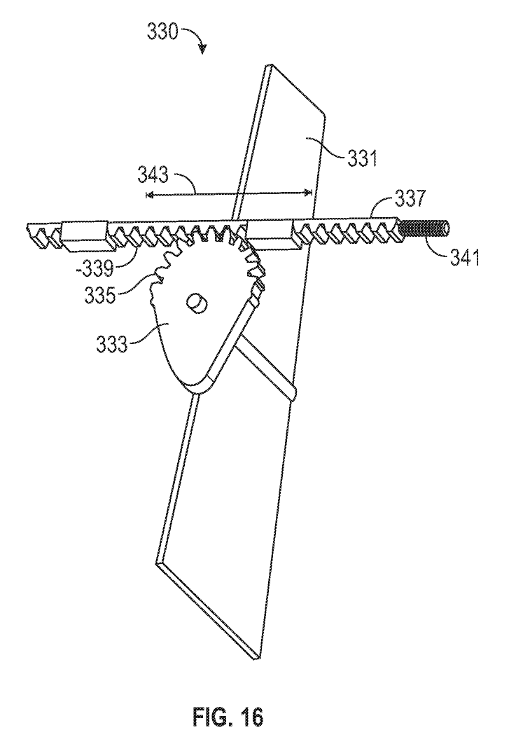

With reference to FIGS. 15 and 16, in another embodiment, the vehicle wheel assembly 14 includes another self-deployed wheel shutter system 330. In this embodiment, the vehicle wheel 18 also has the wheel body 20 and a plurality of openings 22 (e.g., thru-holes) extending completely through the wheel body 20. The openings 22 may have a substantially triangular shape. The self-deployed wheel shutter system 330 has wedge-shaped blades 331 that are perpendicular to the wheel surface to maintain the openings 22 uncovered. Each wedge-shaped blade 331 is held to the wheel body 20 by pegs 333 on the sides of the wedge-shaped blade 331. Every left sided peg 333 includes peg teeth 335 that act like a gear. A bar 337 is coupled to the pegs 333 and includes bar teeth 339. The bar teeth 339 mate with the peg teeth 335. Accordingly, linearly moving the bar 337 (in the direction indicated by double arrow 343) causes the peg 333 to rotate, thereby rotating the wedge-shaped blade 331 about the peg 333 to move the wedge-shaped blade 331 between a first position (in which the openings 22 are uncovered because the wedge-shaped blades 331 are perpendicular to the wheel surface) and a second position (in which the openings 22 are covered because the wedge-shaped blades 331 are flush with the wheel surface). The bar 337 is attached to a spring 341 to facilitate actuation (movement) of the wedge-shaped blades 331 at the predetermined speeds. The spring 341 is attached to the wheel body 20.

While the best modes for carrying out the teachings have been described in detail, those familiar with the art to which this disclosure relates will recognize various alternative designs and embodiments for practicing the teachings within the scope of the appended claims. The self-deployed wheel shutter system 30 illustratively disclosed herein may be suitably practiced in the absence of any element which is not specifically disclosed herein. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings.

1. A vehicle wheel assembly, comprising:
a vehicle wheel including a wheel body, wherein the wheel body has a center, and the vehicle wheel defines a plurality of openings arranged annularly around the center of the wheel body; and
a self-deployed wheel shutter system coupled to the vehicle wheel, wherein the self-deployed wheel shutter system includes:
a hub plate;
an annular rim disposed around the hub plate;
a plurality of shutter flaps arranged annularly around the hub plate, wherein each of the plurality of shutter flaps is pivotally coupled to the hub plate such that a rotation of the hub plate in a first rotational direction causes each of the plurality of shutter flaps to move simultaneously toward the annular rim, each of the plurality of shutter flaps is pivotally coupled to the hub plate such that a rotation of the hub plate in a second rotational direction causes each of the plurality of shutter flaps to move simultaneously toward the annular rim, and the first rotational direction is opposite to the second rotational direction;
wherein the plurality of shutter flaps are movable relative to the vehicle wheel between an extended position and a retracted position;
wherein, in the extended position, the plurality of shutter flaps cover the plurality of openings of the vehicle wheel to preclude air from flowing through the vehicle wheel; and
wherein, when the plurality of shutter flaps are in the retracted position, the openings are exposed, allowing the air to flow through the openings of the vehicle wheel.

2. The vehicle wheel assembly of claim 1, wherein the self-deployed wheel shutter system further includes a guide rail assembly, wherein the guide rail assembly includes a support plate and a plurality of guide rails extending radially outward from the support plate, the annular rim completely surrounds the hub plate, each of the plurality of guide rails is directly coupled to the annular rim, each of the plurality of guide rails extends linearly from the support plate to the annular rim, and each of the plurality of shutter flaps is coupled to one of the plurality of guide rails to guide a movement of the plurality of shutter flaps.

3. The vehicle wheel assembly of claim 2, wherein the support plate has an annular shape and defines a central plate hole, the self-deployed wheel shutter system further includes a torsion spring disposed in the central plate hole, and the torsion spring is coupled to the hub plate to bias the hub plate to rotate toward the second rotational direction in order to simultaneously move the plurality of shutter flaps away from the hub plate.

4. The vehicle wheel assembly of claim 3, wherein the annular rim is configured to be fixed to the vehicle wheel such that the annular rim remains stationary relative to the vehicle wheel.

5. The vehicle wheel assembly of claim 4, wherein the annular rim defines a plurality of arch-shaped slots, and each of the plurality of arch-shaped slots is sized to partially receive one of the plurality of the shutter flaps.

6. The vehicle wheel assembly of claim 5, wherein the hub plate includes an annular plate portion and a plurality of extensions protruding radially outward from the annular plate portion.

7. The vehicle wheel assembly of claim 6, wherein the self-deployed wheel shutter system includes a plurality of pivot pins, each of the plurality of pivot pins pivotally couples one of the plurality of the shutter flaps to one of the plurality of extensions to allow each of the plurality of shutter flaps to pivot relative to the hub plate.

8. The vehicle wheel assembly of claim 7, wherein each of the plurality of guide rails defines a groove, and the groove has a linear shape.

9. The vehicle wheel assembly of claim 8, wherein the self-deployed wheel shutter system further includes a plurality of sliding pins, each of the plurality of sliding pins is coupled to one of the plurality of shutter flaps, and each of the plurality of sliding pins is configured to be slidably received by the groove to allow each of the plurality of shutter flaps to move simultaneously with respect to the annular rim.

10. The vehicle wheel assembly of claim 9, further comprising a base plate configured to be fixed to the vehicle wheel, wherein the hub plate is disposed between the base plate and the support plate.

11. The vehicle wheel assembly of claim 1, wherein each of the plurality of shutter flaps is slidably coupled to the vehicle wheel such that each of the plurality of shutter flaps is configured to slide linearly relative to the center of the vehicle wheel.

12. The vehicle wheel assembly of claim 1, wherein each of the plurality of shutter flaps is configured as a V-shaped foldable flap, the self-deployed wheel shutter system includes a rod pivotally coupled to the vehicle wheel and the V-shaped foldable flap, the V-shaped foldable flap unfolds as the V-shaped foldable flap moves from a retracted position to an extended position.

13. A vehicle, comprising:
a vehicle body;
a vehicle wheel coupled to the vehicle body, wherein the vehicle wheel has a center, and the vehicle wheel defines a plurality of openings; and
a self-deployed wheel shutter system coupled to the vehicle wheel, wherein the self-deployed wheel shutter system includes a plurality of shutter flaps movably coupled to the vehicle wheel such that each of the plurality of shutter flaps is configured to move radially outward away from the center of the vehicle wheel to cover the plurality of openings of the vehicle wheel;
wherein the plurality of shutter flaps are movable relative to the vehicle wheel between an extended position and a retracted position;
wherein, in the extended position, the plurality of shutter flaps cover the plurality of openings of the vehicle wheel to preclude air from flowing through the vehicle wheel; and
wherein, when the plurality of shutter flaps are in the retracted position, the openings are exposed, allowing the air to flow through the openings of the vehicle wheel.

14. The vehicle of claim 13, wherein the self-deployed wheel shutter system further includes a hub plate and an annular rim disposed around the hub plate, the plurality of shutter flaps are arranged annularly around the hub plate, each of the plurality of shutter flaps is pivotally coupled to the hub plate such that a rotation of the hub plate in a first rotational direction causes each of the plurality of shutter flaps to move simultaneously toward the annular rim, each of the plurality of shutter flaps is pivotally coupled to the hub plate such that a rotation of the hub plate in a second rotational direction causes each of the plurality of shutter flaps to move simultaneously toward the annular rim, and the first rotational direction is opposite to the second rotational direction, the self-deployed wheel shutter system further includes a guide rail assembly including a support plate and a plurality of guide rails extending radially outward from the support plate, each of the plurality of guide rails is directly coupled to the support plate, the annular rim completely surrounds the hub plate, each of the plurality of guide rails is directly coupled to the annular rim, each of the plurality of guide rails extends linearly from the support plate to the annular rim, each of the plurality of shutter flaps is coupled to one of the plurality of guide rails to guide a movement of the plurality of shutter flaps, the plurality of shutter flaps completely cover the plurality of openings of the vehicle wheel in the extended position to preclude air from flowing through the vehicle wheel, the support plate has an annular shape and defines a central plate hole, the self-deployed wheel shutter system further includes a torsion spring disposed in the central plate hole, the torsion spring is coupled to the hub plate to bias the hub plate to rotate toward the second rotational direction in order to simultaneously move the plurality of shutter flaps away from the hub plate, and the annular rim is configured to be fixed to a vehicle wheel such that the annular rim remains stationary relative to the vehicle wheel, the self-deployed wheel shutter system further includes a plurality of sliding pins, each of the plurality of sliding pins is coupled to one of the plurality of shutter flaps, each of the plurality of guide rails defines a groove, and the groove has a linear shape, each of the plurality of sliding pins is configured to be slidably received by the groove to allow each of the plurality of shutter flaps to move simultaneously with respect to the annular rim.

15. The vehicle of claim 14, wherein the annular rim defines a plurality of arch-shaped slots, and each of the plurality of arch-shaped slots is sized to partially receive one of the plurality of the shutter flaps, and the self-deployed wheel shutter system further includes a hub cap directly coupled to all of the plurality of guide rails, and the hub cap partially covers all of the plurality of shutter flaps.

16. The vehicle of claim 15, wherein the hub plate includes an annular plate portion and a plurality of extensions protruding radially outward from the hub plate, and each of the plurality of extensions is directly coupled to the annular plate portion.

17. The vehicle of claim 16, wherein the self-deployed wheel shutter system includes a plurality of pivot pins, each of the plurality of pivot pins pivotally and directly couples one of the plurality of the shutter flaps to one of the plurality of extensions to allow each of the plurality of shutter flaps to pivot relative to the hub plate.

18. The vehicle of claim 13, wherein each of the plurality of shutter flaps is slidably coupled to the vehicle wheel such that each of the plurality of shutter flaps is configured to slide linearly relative to the center of the vehicle wheel.

19. The vehicle of claim 13, wherein each of the plurality of shutter flaps is configured as a V-shaped foldable flap, the self-deployed wheel shutter system includes a rod pivotally coupled to the vehicle wheel and the V-shaped foldable flap, the V-shaped foldable flap unfolds as the V-shaped foldable flap moves from a retracted position to an extended position.

20. The vehicle of claim 19, wherein the rod has a first rod end and a second rod end opposite the first rod end, the first rod end is pivotally and directly coupled to the vehicle wheel, the second rod end is pivotally and directly coupled to the V-shaped foldable flap.
